(19) United States
(12) Patent Application Publication
(10) Pub. No.: US 2010/0189510 A1
(43) Pub. Date: Jul. 29, 2010

(54) SOIL TREATMENT METHOD

(76) Inventor: Andrew William Armstrong, Essex (GB)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/664,908

(22) PCT Filed: Jun. 20, 2008
(86) PCT No.: PCT/GB2008/050474

§ 371 Date: Dec. 16, 2009

(30) Foreign Application Priority Data
Jun. 20, 2007 (GB) 0711869.8

(51) Int. Cl. B09C 1/08

(52) U.S. Cl. 405/128.75

(57) ABSTRACT

A method for treating soil at a site contaminated with organic contaminants, comprises: (a) determining site characteristics, and sampling a volume of soil; (b) determining soil characteristics, and identifying and quantifying contaminants; (c) selecting a treatment composition appropriate to the contaminants and soil and site characteristics; (d) calculating an effective amount of treatment composition appropriate to the contaminants and soil and site characteristics, and in the range of from 2% to 12% by weight, relative to the weight of soil being treated; (e) excavating a volume of contaminated soil from the site; (f) combining the effective amount of treatment composition with the excavated soil; (g) mechanically mixing the excavated soil with the treatment composition; and (h) aerating the treated soil; and optionally: (i) conditioning the treated soil; and at least one of: (j) back-filling the site with the treated soil; (k) storing the treated soil; (1) disposing of the treated soil; and/or (m) transporting said treated soil for use at a further site.

This invention relates to a soil treatment method. In particular, it relates to a method for treating contaminated soils at a site so as to render the site free from contaminants. The method has been developed particularly for treating soils contaminated with volatile organic compounds (VOCs) such as hydrocarbons.

The treatment of soil contaminated with undesirable materials such as volatile organic compounds (VOCs), heavy metals or pesticides, is an essential preliminary step in the development of sites for construction, landscaping or other ground engineering projects. Conventionally, such contaminants have been dealt with by so-called “dig and dump” methods, but these procedures are costly in terms of the material which must be brought in to replace the excavated soil. Moreover, dig and dump methods are now generally viewed as being environmentally unacceptable.

Soil stabilisation and solidification methods, where binders are added to the contaminated soil to interact with the contaminants, have also been proposed. However, these methods serve merely to solidify or encapsulate the contaminants, so as to reduce their mobility, but do not in fact remove the contaminants from the soil, nor break them down into more environmentally acceptable materials.

Other conventional methods of treating soil so as to remove undesirable contaminants include bioremediation, where the contaminants are treated by the use of organic nutrients or biological agents. This method is often used in combination with the use of heat, windows, or air sparging techniques, all of which are thought to promote the action of the organic nutrients or biological agents.

Although bioremediation techniques are effective to some degree, they tend to be rather slow, with a typical process taking many weeks or months to complete. Bioremediation processes also have limitations in their ability to break down soil particles, and this problem is particularly acute where the site to be treated has a high content of cohesive soils such as clays. Furthermore, the organic processes employed to remove the contaminants leave behind further benign organic residues in their place. The presence of these organic residues means that the treated soil will still be geotechnically unsound. Therefore, whilst bioremediation is a suitable technique where a site is intended to be landscaped or otherwise developed, it cannot be used by itself where a site is intended to be built upon.

The present invention seeks to address the above issues by providing a quick, environmentally acceptable method for removing unwanted contaminants from soil at a site, and which results in the production of a geotechnically sound material, such that the site is rendered suitable for construction.

Therefore, according to the present invention, there is provided a method for treating soil at a site contaminated with organic contaminants, comprising the steps of:
(a) determining characteristics of the site, including proximity of water courses, habitation and physical constraints, and sampling a volume of soil from said site;
(b) analysing said soil sample to determine soil characteristics, including particle size distribution and moisture content, and to identify and quantify contaminants therewithin;
(c) selecting a treatment composition appropriate to the identity and quantity of said contaminants and said soil and site characteristics determined in steps (a) and (b);
(d) calculating an effective amount of said treatment composition to treat said contaminants in a unit volume of soil at the site, said effective amount of treatment composition being determined by the identity and quantity of said contaminants and soil and site characteristics determined in steps (a) and (b), and the identity of the treatment composition selected in step (c), and being in the range of from 2% to 12% by weight, relative to the weight of soil being treated;
(e) excavating a volume of contaminated soil from the site;
(f) combining said selected treatment composition with the excavated soil in a ratio corresponding to said calculated effective amount;
(g) mechanically mixing the excavated soil with the soil treatment composition; and
(h) aerating said treated soil by passing it over screening machinery;
   and optionally:
(i) conditioning said treated soil by mixing with water and/or a binder composition;
   and subsequently performing at least one of the following steps:
(j) back-filling the excavated site with said treated soil;
(k) storing said treated soil for future use;
(l) disposing of said treated soil at landfill; and/or
(m) transporting said treated soil for use at a further site.

The term “soil” as used herein should be interpreted broadly to include substantially all particulate or aggregate mineral material.

The method according to the present invention has been developed for the treatment of soil contaminated with organic contaminants, such as volatile organic compounds (VOCs), and most particularly for treating soil contaminated with hydrocarbons. It is also envisaged that the method will find use for the treatment of soil which is also contaminated with other contaminants such as heavy metals or pesticides. In contrast to conventional techniques such as bioremediation, the method of the present invention is particularly suitable for use in treating contaminated soils having a high content of cohesive material, such as clays.

The site characteristics determined in step (a) of the method of the present invention include proximity of water courses and habitation, which could be impacted both by the contaminants and the treatment composition. The physical constraints of the site must also be taken into account, both in terms of the machinery which can be used, and the capability for storing excavated soil on the site—whether contaminated, part-treated or decontaminated.

Step (b) of the method of the present invention includes analysing the soil to determine its particle size distribution and moisture content. This will have an impact on the effective amount of treatment composition to be calculated in step (d), as well as the amount of mixing that will be required in step (g). For example, more cohesive soils will require greater amounts of treatment composition in order to break down the soil structure, prior to aeration in step (h). Silty and granular soils, on the other hand, do not require any such breaking-down in order to enhance the aeration process. Here, the treatment composition is used solely to volatilise the contaminants, and so less composition is required.

The term “granular” is used herein to refer to soils having particles sizes greater than 0.05 mm; the terms “silt” or “silty” are used herein to refer to soils having particle sizes in the range of 0.002 to 0.05 mm; and the terms “cohesive” or “clay” are used herein to refer to soils having particle sizes below 0.002 mm.

The nature of the contaminants identified in step (b) will inevitably also have an impact on the make-up and effective amount of the treatment composition to be determined in steps (c) and (d), and the amount of mixing that will be required following step (f). As will be described in more detail below, soil contaminated with petrol will require relatively small amounts of treatment composition and mixing; whilst soil contaminated with diesel will require more treatment composition and more mixing; and soil contaminated with oils will require still greater amounts of treatment composition and mixing.

The term “petrol” as used herein refers to hydrocarbons having in the range of from 4 to 10 carbon atoms per molecule; the term “diesel” as used herein refers to hydrocarbons having in the range of from 10 to 18 carbon atoms per molecule; and the term “oils” as used herein refers to hydrocarbons having in the range of from 18 to 26 carbon atoms per molecule. Additionally, the presence of other contaminants such as heavy metals or pesticides in the soil will generally require additional binders to be added in step (i), as will be discussed in more detail below.

The treatment composition selected in step (c) of the method of the present invention preferably comprises one or more components selected from carbonates, oxides and hydroxides of calcium. More preferably, the composition comprises calcium oxide, also referred to as lime or quicklime. Most preferably, the treatment composition consists essentially of calcium oxide.

Whilst the scope of the present invention is not bound by any theory, it is believed that the action of calcium oxide (quicklime) on hydrocarbon contaminants can be explained as follows: Firstly, the quicklime reacts with the contaminated soil material, breaking down the soil structure and thus increasing the surface area. This in turn makes the excavated soil material more granular in composition, aiding its suitability for running over screening machinery, which serves to aerate the soil and further break down the soil structure. Secondly, upon contact of the quicklime with the contaminated soil material, an exothermic reaction is generated, and the resultant heat serves to volatilise and vaporise the hydrocarbon contaminants.

Using the method of the present invention, it is believed that contamination levels at a typical construction site can be brought down to environmentally acceptable levels within a matter of days, rather than the weeks and months typically required by conventional methods.

In step (d) of the method of the present invention, the effective amount of the treatment composition is preferably calculated as a percentage weight relative to the weight of soil being treated. Most preferably, the effective amount of treatment composition is in the range of 2% to 12% by weight, relative to the weight of soil being treated.

Calculation of the effective amount of treatment composition will be influenced by two major factors: the nature of the contaminant(s) and the nature of the soil(s). The nature of the contaminant(s) influences calculation of the effective amount as follows:
for petrol, the effective amount of treatment composition will be in the range of from 2% to 6% by weight, relative to the weight of soil being treated;
for diesel, the amount will be in the range of from 3% to 8%; and
for oils, the amount will be in the range of from 6% to 12%.

Similarly, the nature of the soil(s) influences calculation of the effective amount, as follows:
for granular soils, the effective amount of treatment composition will be in the range of from 2% to 6% by weight, relative to the weight of soil being treated;
for silt, the amount will be in the range of from 3% to 9%; and
for clay, the amount will be in the range of from 4% to 12%.

As will be appreciated, the above ranges for the effective amount of treatment composition give rise to different preferred ranges for different combinations of contaminant(s) and soil(s), as follows:
for granular soil contaminated with petrol, the effective amount of treatment composition will be in the range of from 2% to 6% by weight, relative to the weight of soil being treated;
for silt contaminated with petrol, the effective amount will be in the range of from 3% to 6% by weight;
for clay contaminated with petrol, the effective amount will be in the range of from 4% to 6% by weight;
for granular soil contaminated with diesel, the effective amount will be in the range of from 3% to 6% by weight;
for silt contaminated with diesel, the effective amount will be in the range of from 3% to 8% by weight;
for clay contaminated with diesel, the effective amount will be in the range of from 4% to 8% by weight;
for granular soil contaminated with oil, the effective amount will be substantially 6% by weight;
for silt contaminated with oil, the effective amount will be in the range of from 6% to 9% by weight; and
for clay contaminated with oil, the effective amount will be in the range of from 6% to 12% by weight.

It should be appreciated that, where more than one type of contaminant and/or more than one type of soil, is present in a sample, this will lead to variations in the preferred ranges as outlined above.

The effective amount of treatment composition calculated in step (d) will also be influenced by environmental factors at a site such as wind, rain, air humidity, air temperature, soil temperature and soil moisture content, which will inevitably vary from site to site and process to process. Greater amounts of treatment composition will be required in cold and damp conditions, in order to generate the required heat. In such conditions, the length of time required for the VOCs to volatilise may also need to be increased.

Step (g) preferably includes pulverising the excavated soil so as to increase its surface area. Step (g) may also include mixing the soil treatment composition with the excavated soil using a spreader and rotovator, and may occasionally involve adding water to the excavated soil, to enhance the mobility of the treatment composition.

Step (f) may include a sub-step of pre-screening the excavated soil, prior to addition of the soil treatment composition, in order to remove large stones, rocks, and bricks. Pre-screening is generally only required for granular soils, and is not practical for cohesive, silty or saturated soils.

The screening process referred to in step (h) preferably includes processes of elevating, conveying and/or discharging the combined soil and treatment composition, in order to promote aeration thereof. Carrying out these physical processes on the mixed and pulverised materials—which will by now be substantially granular and friable in nature—aids dispersion of the volatilised hydrocarbons into the air.

Steps (f) to (h) may be repeated until contaminant content in the treated soil is reduced to a satisfactory level. Where these steps are repeated, the effective amount of treatment composition may be added to the soil in several portions, with each repetition of step (f). This is particularly preferred for silty and cohesive soils. For cohesive soils, it is also preferred that the treated soil is allowed to mellow after step (h) before repeating step (f). “Mellowing” in this context means allowing the calcium oxide sufficient time to interact with cohesive material present in the soil, so as to render it friable and thus easier to break down.

The contaminant content referred to above may be determined by standard laboratory testing techniques, or alternatively may be determined on site by photoionisation detection (PID). This method is particularly suitable for volatile hydrocarbon contaminants such as petrol. The assessment of contaminant content is preferably carried out before and/or after step in the sequence of method steps (f) to (h), and before and/or after each repetition of the sequence of method steps (f) to (h).

Method step (i) is particularly required where the presence of other contaminants such as heavy metals or pesticides has been identified in step (b). Suitable materials for use in the binder composition may be selected from: cement, ground granulated blast-furnace slag (GGBS), pulverised fuel ash (PFA), and bentonite clays.

Whilst the soil treatment method of the present invention has been developed as a ‘stand-alone’ method, it is envisaged that it may be used in combination with other soil treatment methods such as soil stabilisation and solidification.

The scope of the present invention also extends to encompass soil, or other aggregate materials, treated according to a method as hereinbefore described. It should also be appreciated that the method of the present invention may be utilised for the treatment of material excavated from a remote location and transported to a treatment site, as well as the on-site treatment of locally excavated material.

In order that the present invention may be more clearly understood, a preferred embodiment will now be described in detail, though only by way of example, with reference to the following drawings, in which:

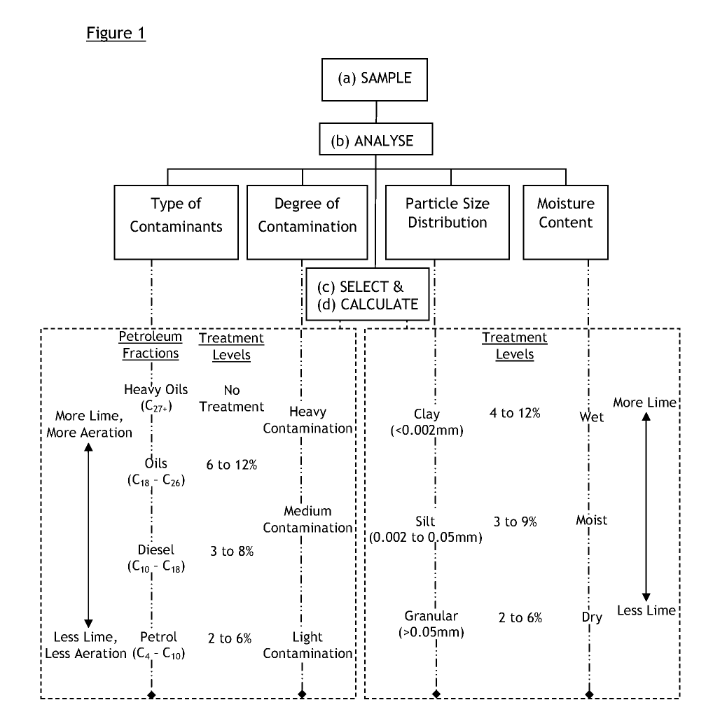

FIG. 1 is a schematic diagram illustrating the preliminary steps of the method of the present invention; and

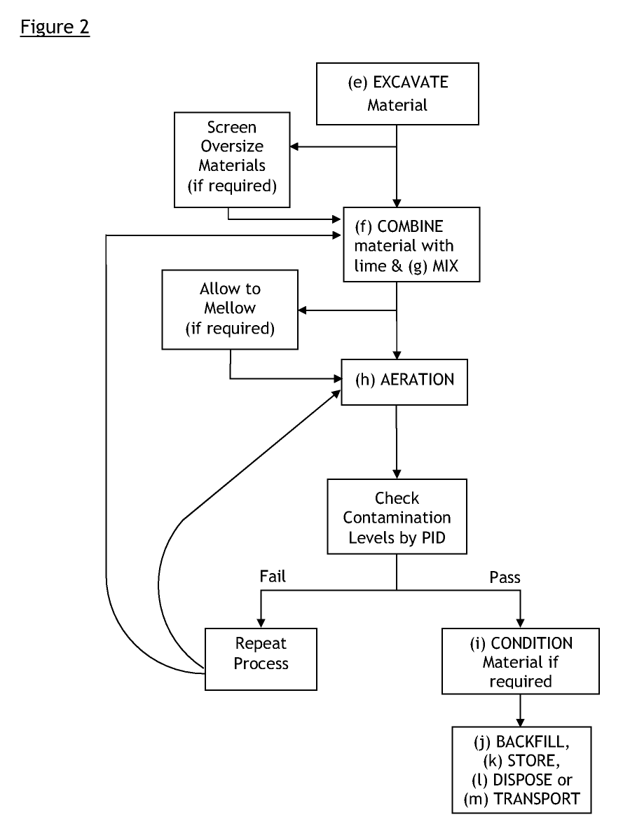

FIG. 2 is a schematic flow-chart diagram illustrating the material treatment steps of the method of the present invention.

Referring first to FIG. 1, there is shown an illustration of the preliminary process of analysing the soil to be treated, selecting a treatment composition appropriate to the soil properties, and calculating an effective amount of said treatment composition. The preliminary process begins by sampling (a) a volume of soil from the site. The sample is then analysed (b) to identify and quantify the type of contaminants and degree of contamination present, and to determine soil characteristics, namely particle size distribution and moisture content. The contaminants will generally be characterised as petrol, diesel or oil, and the soil will be characterised as granular, silt or clay.

The treatment composition to be utilised is then selected (c) and the required amount calculated (d) according to the contaminants and soil characteristics determined in step (b), as described above. FIG. 1 shows a simplified preliminary process in which the soil sample is known to contain hydrocarbon contaminants, and so step (c) has effectively already been determined, with lime (calcium oxide) being selected as the principal active component for the soil treatment composition. The required amount of lime is then calculated (d) on a sliding scale, taking into account each of the variables determined in step (b), as follows:

Type of Contaminants: more volatile hydrocarbon contaminants such as petrol require less lime to be used in the main part of the process, and also require less aeration during the process; less volatile contaminants such as diesel or heavier oil fractions will require progressively larger amounts of lime, and more aeration. For soil contaminated with the heaviest hydrocarbon oil fractions, having 27 or more carbon atoms per molecule, the method of the present invention is not suitable, and these must instead be dealt with by conventional methods.

Degree of Contamination: light contamination calls for lesser amounts of lime; medium contamination requires treatment with greater amounts of lime; and heavy contamination again renders the soil unsuitable to be treated by the method of the present invention.

Particle Size Distribution: granular soils require the least lime; silty soils will require treatment with more lime; and soils containing clays will require still greater amounts of lime.

Moisture Content: as would be expected, dry soils require the least lime; moist soils require greater amounts; and wet soils require the greatest amounts of lime.

The above four factors combine to determine the precise amount of lime required to treat any particular soil sample.

Referring now to FIG. 2, there is shown an illustration of the main part of the soil treatment method according to the present invention. Following the preliminary method steps discussed above with reference to FIG. 1, a volume of soil is excavated (e) ready for treatment. The excavated material may either be treated on site, or may be transported for treatment at a remote location.

As shown in FIG. 2, if the excavated volume of soil contains over-sized objects such as stones and rocks, the method may be adapted to include an intermediary step of screening the material so as to remove these, before continuing to the initial treatment steps where the material is combined (f) and mechanically mixed (g) with the treatment composition determined in the preliminary method steps discussed above with reference to FIG. 1.

If the excavated material contains cohesive or clay-based soils, the method may again be adapted to include a step of allowing the material to mellow, before proceeding to step (h) where the treated soil is aerated by being passed over screening machinery. Following this, the residual contamination levels are assessed by standard laboratory testing techniques, or by photo-ionisation detection (PID) if the contaminants are volatile hydrocarbons such as petrol. If the contamination levels are still higher than a pre-determined target level, the process—or parts thereof—is repeated. Depending on the degree to which the target level is exceeded, and the soil characteristics, the material may either be returned to the initial treatment stages to be combined (f) and mixed (g) with further lime; or may simply be returned for further aeration (h). Adding further lime is generally appropriate for silt and clay-based soils.

Once the contamination levels have been reduced to an acceptable level, the material is then checked and conditioned (i), if required, by mixing with water and/or a binding composition. This is particularly required where the material additionally contains other contaminants such as heavy metals or pesticides.

Finally, the treated material is either backfilled (j) into the site from which it was excavated, stored (k) at a suitable location for future use, safely disposed of (I) at landfill, or transported (m) for use at a further site

### EXAMPLES

The present invention will now be further illustrated with reference to experimental observations and data.

### Example I

Seven soil samples were taken from a test site located in Durham, United Kingdom, in accordance with step (a) of the method of the present invention. The soil samples were then analysed to determine soil characteristics and contaminants according to step (b) of the method of the present invention. The soil was found to be granular and dry, and both petrol and diesel contaminants were identified, said contaminants having between 4 and 16 carbon atoms per molecule. Taking these factors into account, a quicklime treatment composition was selected, in accordance with step (c) of the method of the present invention, and an effective amount of 3% by weight of said treatment composition, relative to the weight of soil to be treated, was calculated in accordance with step (d) of the method of the present invention.

The concentration of contaminant in each sample was then measured and recorded, following which each sample was subjected to the material treatment steps (f) to (h) of the method of the present invention, as described above with reference to FIG. 2. The concentration of contaminant in each sample following treatment was then measured and recorded.

### Example II

The concentration of contaminants in the seven samples from Example I, before and after treatment according to the method of the present invention, are shown in the table below:

| | | Concentration | | |
|---|---|---|---|---|
| | | before | Target | Concentration |
| | | Treatment | Concentration | after Treatment |
| Sample | Contaminant | (mg/kg) | (mg/kg) | (mg/kg) |
| 1 | TPH | 2868.8 | 1000 | <10 |
| 2 | TPH | 4353.3 | 1000 | <10 |
| 3 | TPH | 1480.4 | 1000 | <10 |
| 4 | TPH | 220894 | 1000 | <10 |
| 5 | PAH | 493 | 50 | <10 |
| 6 | PAH | 126 | 50 | <10 |
| 7 | PAH | 41910 | 50 | <10 |

Notes:
“TPH” = Total Petroleum Hydrocarbons
“PAH” = Polycylic Aromatic Hydrocarbons
“Target Concentration” = maximum permissible level of contamination set by UK Environment Agency

As can be seen, the results achieved in this test far exceed the levels set by the UK Environment Agency, with contaminant levels of less than 10 mg/kg being achieved in each sample.

1. A method for treating soil at a site contaminated with organic contaminants, comprising the steps of:
(a) determining characteristics of the site, including proximity of water courses, habitation and physical constraints, and sampling a volume of soil from said site;
(b) analysing said soil sample to determine soil characteristics, including particle size distribution and moisture content, and to identify and quantify contaminants therewithin;
(c) selecting a treatment composition appropriate to the identity and quantity of said contaminants and said soil and site characteristics determined in steps (a) and (b);
(d) calculating an effective amount of said treatment composition to treat said contaminants in a unit volume of soil at the site, said effective amount of treatment composition being determined by the identity and quantity of said contaminants and soil and site characteristics determined in steps (a) and (b), and the identity of the treatment composition selected in step (c), and being in the range of from 2% to 12% by weight, relative to the weight of soil being treated;
(e) excavating a volume of contaminated soil from the site;
(f) combining said selected treatment composition with the excavated soil in a ratio corresponding to said calculated effective amount;
(g) mechanically mixing the excavated soil with the soil treatment composition; and
(h) aerating said treated soil by passing it over screening machinery;
and optionally:
(i) conditioning said treated soil by mixing with at least one of water and a binder composition;
and subsequently performing at least one of the following steps:
(j) back-filling the excavated site with said treated soil;
(k) storing said treated soil for future use;
(l) disposing of said treated soil at landfill;
(m) transporting said treated soil for use at a further site

2. The soil treatment method as claimed in claim 1, wherein the treatment composition selected in step (c) comprises one or more components selected from carbonates, oxides and hydroxides of calcium.

3. The soil treatment method as claimed in claim 1, wherein the treatment composition selected in step (c) comprises calcium oxide.

4. (canceled)

5. The soil treatment method as claimed in claim 1, for treating soil contaminated with volatile organic compounds.

6. The soil treatment method as claimed in claim 1, for treating soil contaminated with hydrocarbons, wherein in step (b), the hydrocarbon contamination identified is characterised as a contaminant selected from petrol, diesel and oil, according to number of carbon atoms per molecule, and the soil analysed is characterised as granular, silt or clay, according to particle size.

7. (canceled)

8. The soil treatment method as claimed in claim 6, wherein:
where the hydrocarbon contamination is characterised as petrol, the effective amount of treatment composition calculated in step (d) is in the range of from 2% to 6% by weight, relative to the weight of soil being treated;
where the hydrocarbon contamination is characterised as diesel, the effective amount of treatment composition calculated in step (d) is in the range of from 3% to 8% by weight, relative to the weight of soil being treated; and
where the hydrocarbon contamination is characterised as oil, the effective amount of treatment composition calculated in step (d) is in the range of from 6% to 12% by weight, relative to the weight of soil being treated.

9. (canceled)

10. (canceled)

11. The soil treatment method as claimed in claim 6, wherein:
where the soil is characterised as granular, the effective amount of treatment composition calculated in step (d) is in the range of from 2% to 6% by weight, relative to the weight of soil being treated;
where the soil is characterised as silt, the effective amount of treatment composition calculated in step (d) is in the range of from 3% to 9% by weight, relative to the weight of soil being treated; and
where the soil is characterised as clay, the effective amount of treatment composition calculated in step (d) is in the range of from 4% to 12% by weight, relative to the weight of soil being treated.

12. (canceled)

13. (canceled)

14. The soil treatment method as claimed in claim 6, wherein the hydrocarbon contamination is characterised as petrol, and wherein:
where the soil is characterised as granular, the effective amount of treatment composition calculated in step (d) is in the range of from 2% to 6% by weight, relative to the weight of soil being treated;
where the soil is characterised as silt, the effective amount of treatment composition calculated in step (d) is in the range of from 3% to 6% by weight, relative to the weight of soil being treated; and
where the soil is characterised as clay, the effective amount of treatment composition calculated in step (d) is in the range of from 4% to 6% by weight, relative to the weight of soil being treated.

15. (canceled)

16. (canceled)

17. The soil treatment method as claimed in claim 6, wherein the hydrocarbon contamination is characterised as diesel, and wherein:
where the soil is characterised as granular, the effective amount of treatment composition calculated in step (d) is in the range of from 3% to 6% by weight, relative to the weight of soil being treated;
where the soil is characterised as silt, the effective amount of treatment composition calculated in step (d) is in the range of from 3% to 8% by weight, relative to the weight of soil being treated; and
where the soil is characterised as clay, the effective amount of treatment composition calculated in step (d) is in the range of from 4% to 8% by weight, relative to the weight of soil being treated.

18. (canceled)

19. (canceled)

20. The soil treatment method as claimed in claim 6, wherein the hydrocarbon contamination is characterised as oil, and wherein:
where the soil is characterised as granular, the effective amount of treatment composition calculated in step (d) is substantially 6% by weight, relative to the weight of soil being treated;
where the soil is characterised as silt, the effective amount of treatment composition calculated in step (d) is in the range of from 6% to 9% by weight, relative to the weight of soil being treated; and
where the soil is characterised as clay, the effective amount of treatment composition calculated in step (d) is in the range of from 6% to 12% by weight, relative to the weight of soil being treated.

21. (canceled)

22. (canceled)

23. The soil treatment method as claimed in claim 1, wherein the sequence of method steps (f) to (h) is repeated until contaminant content in the treated soil is reduced to a satisfactory level.

24. The soil treatment method as claimed in claim 23, wherein the treated soil is allowed to mellow after step (h) before repeating step (f).

25. The soil treatment method as claimed in claim 23, wherein the contaminant content is determined by photoionisation detection.

26. The soil treatment method as claimed in claim 1, wherein step (g) includes pulverising the excavated soil.

27. The soil treatment method as claimed in claim 1, wherein step (g) includes mixing the soil treatment composition with the excavated soil using a spreader and rotovator.

28. The soil treatment method as claimed in claim 1, wherein step (g) includes adding water to the excavated soil.

29. The soil treatment method as claimed in claim 1, wherein step (f) includes pre-screening the excavated soil, prior to addition of the soil treatment composition.

30. The soil treatment method as claimed in claim 1, wherein step (h) includes at least one of elevating, conveying and discharging the combined soil and treatment composition to promote aeration.

31. The soil treatment method as claimed in claim 1, wherein the contaminant content in the soil is assessed before and/or after each step in the sequence of method steps (f) to (h).

32. The soil treatment method as claimed in claim 23, wherein the contaminant content in the soil is assessed before and/or after each repetition of the sequence of method steps (f) to (h).
